(19) United States
(12) Patent Application Publication
(10) Pub. No.: US 2014/0014292 A1
(43) Pub. Date: Jan. 16, 2014

(54) CONTROLLING DATA CENTER AIRFLOW

(71) Applicants: Jeremy Rice, San Jose, CA (US); Pascal Kam, Union City, CA (US); Gregory P. Imwalle, Mountain View, CA (US); Eehern J. Wong, El Macero, CA (US)

(72) Inventors: Jeremy Rice, San Jose, CA (US); Pascal Kam, Union City, CA (US); Gregory P. Imwalle, Mountain View, CA (US); Eehern J. Wong, El Macero, CA (US)

(73) Assignee: GOOGLE INC., Mountain View, CA (US)

(21) Appl. No.: 13/549,784

(22) Filed: Jul. 16, 2012

(51) Int. Cl. G05D 16/00; F28F 27/00; G05D 23/00; F28F 9/007

(52) U.S. Cl. 165/11.1; 165/67; 165/281; 165/287; 165/279

(57) ABSTRACT

A data center cooling system includes a plurality of cooling units positioned adjacent a warm air plenum that is in airflow communication with a plurality of electronic devices supported in a plurality of racks. Each of the cooling units includes a heat exchanger arranged to cool warmed air circulated into the warm air plenum from a human-occupiable workspace adjacent the plurality of racks opposite the plurality of cooling units, and a fan arranged to circulate the warmed air from the warm air plenum through the heat exchanger and to the human-occupiable workspace. The cooling system includes a control system electrically coupled to the fan and configured to modulate a fan speed of the fan of each cooling unit to induce a pressure gradient in the warm air plenum.

### BACKGROUND

This disclosure relates to controlling airflow to areas that contain electronic equipment, such as data centers.

### BACKGROUND

Computer users often focus on the speed of computer microprocessors, e.g., megahertz and gigahertz. Many forget that this speed often comes with a cost—higher power consumption. For one or two home PCs, this extra power may be negligible when compared to the cost of running the many other electrical appliances in a home. But in data center applications, where thousands of microprocessors may be operated, electrical power requirements can be very important.

Power consumption is also, in effect, a double whammy. Not only must a data center operator pay for electricity to operate its many computers, but the operator must also pay to cool the computers. That is because, by simple laws of physics, all the power has to go somewhere, and that somewhere is, in the end, conversion into heat. A pair of microprocessors mounted on a single motherboard can draw hundreds of watts or more of power. Multiply that figure by several thousand, or tens of thousands, to account for the many computers in a large data center, and one can readily appreciate the amount of heat that can be generated. It is much like having a room filled with thousands of burning floodlights. The effects of power consumed by the critical load in the data center are often compounded when one incorporates all of the ancillary equipment required to support the critical load.

Thus, the cost of removing all of the heat can also be a major cost of operating large data centers. That cost typically involves the use of even more energy, in the form of electricity and natural gas, to operate chillers, condensers, pumps, fans, cooling towers, and other related components. Heat removal can also be important because, although microprocessors may not be as sensitive to heat as are people, increases in temperature can cause great increases in microprocessor errors and failures. In sum, a data center requires a large amount of electricity to power the critical load, and even more electricity to cool the load.

### SUMMARY

This document discusses systems and techniques for managing airflow in a data center. In one general implementation, a data center cooling system includes a plurality of cooling units positioned adjacent a warm air plenum that is in airflow communication with a plurality of electronic devices supported in a plurality of racks. Each of the cooling units includes a heat exchanger arranged to cool warmed air circulated into the warm air plenum from a human-occupiable workspace adjacent the plurality of racks opposite the plurality of cooling units, and a fan arranged to circulate the warmed air from the warm air plenum through the heat exchanger and to the human-occupiable workspace. The system includes a control system electrically coupled to the fan and configured to modulate a fan speed of the fan of each cooling unit to induce a pressure gradient in the warm air plenum.

In a first aspect combinable with the general implementation, the control system comprises a plurality of first level controllers, each of the first level controllers associated with a respective cooling unit and configured to control the fan speed of the fan of the respective cooling unit based on a received local pressure setpoint.

In a second aspect combinable with any of the previous aspects, the local pressure setpoint comprises a pressure setpoint for a location in the warm air plenum directly adjacent the respective cooling unit.

A third aspect combinable with any of the previous aspects includes a second level controller in communication with each of the first level controllers, the second level controller configured to determine the local pressure setpoint for each of the first level controllers based on a current fan speed of the fan of each cooling unit.

In a fourth aspect combinable with any of the previous aspects, the second level controller is configured to determine if a pressure in a region of the warm air plenum has surpassed a predetermined threshold level.

In a fifth aspect combinable with any of the previous aspects, the second level controller is configured to modulate the fan speed of the fan of each cooling unit in response to determining that a pressure in a region of the warm air plenum has surpassed the threshold level.

In a sixth aspect combinable with any of the previous aspects, the second level controller is configured to determine, from among the fans of the plurality of cooling units, a fan operating at a highest current fan speed.

In a seventh aspect combinable with any of the previous aspects, the local pressure setpoint for each of the first level controllers is sufficient to cause the plurality of first level controllers to drive the fan of each cooling unit at a speed substantially equal to the highest current fan speed.

In an eighth aspect combinable with any of the previous aspects, the local pressure setpoint for each of the first level controllers is sufficient to cause the plurality of first level controllers to drive the fan of each cooling unit at a substantially equal fan speed, which is lower than the highest current fan speed.

In a ninth aspect combinable with any of the previous aspects, the second level controller is configured to determine an average current fan speed of the fans of the plurality of cooling units.

In a tenth aspect combinable with any of the previous aspects, the local pressure setpoint for each of the first level controllers is sufficient to cause the plurality of first level controllers to drive the fan of each cooling unit at a speed substantially equal to the average current fan speed.

In an eleventh aspect combinable with any of the previous aspects, the second level controller is configured to determine the local pressure setpoint for each of the first level controllers dynamically, at predetermined time intervals.

In a twelfth aspect combinable with any of the previous aspects, the warm air plenum extends continuously lengthwise along a row of racks, and is defined between one side of the heat exchangers and the racks.

In a thirteenth aspect combinable with any of the previous aspects, the pressure gradient extends between two locations in the warm air plenum separated lengthwise along the row of racks.

In a fourteenth aspect combinable with any of the previous aspects, one of the two locations is directly adjacent a first of the cooling units and the other of the two locations is directly adjacent a second of the cooling units.

In a fifteenth aspect combinable with any of the previous aspects, each of the cooling units further comprises a pressure sensor arranged to measure a local plenum pressure proximate the fan, the pressure sensor in communication with the control system.

In a sixteenth aspect combinable with any of the previous aspects, the pressure gradient is sufficient to cause air in the warm air plenum to flow from a localized high airflow region of the warm air plenum to a localized low airflow region of the warm air plenum.

In a seventeenth aspect combinable with any of the previous aspects, the control system is configured to control the fan of a first cooling unit to circulate air from a localized high airflow region adjacent the first cooling unit, along the warm air plenum, towards a localized low airflow region adjacent a second cooling unit that is spaced apart from the first cooling unit.

In an eighteenth aspect combinable with any of the previous aspects, each of the cooling units further comprises a control valve coupled to the heat exchanger, the control valve being in communication with the control system.

In a nineteenth aspect combinable with any of the previous aspects, the control system is further configured to individually modulate the control valve of each cooling unit, to open or close the control valve to substantially maintain an approach temperature setpoint associated with the cooling unit.

In a twentieth aspect combinable with any of the previous aspects, the approach temperature is defined by a difference between a temperature of an airflow circulated from the cooling unit and a temperature of a cooling fluid circulated to the cooling unit.

In a twenty-first aspect combinable with any of the previous aspects, the control system is configured to determine, from among the fans of the plurality of cooling units, a fan operating at a highest current fan speed; and drive the fan of each cooling unit at a speed substantially equal to the highest current fan speed.

In another general implementation, a method for cooling a data center includes operating a plurality of fans to circulate air from a human-occupiable workspace, through one or more computer racks into a warm air plenum a warm air plenum, and through a plurality of heat exchangers, each of the fans being associated with one or more particular heat exchangers of the plurality of heat exchangers; monitoring a localized pressure in the warm air plenum proximate each of the fans; determining a local pressure setpoint for each of the plurality of fans to induce a pressure gradient in the warm air plenum; and modulating a fan speed of each of the plurality of fans to satisfy the local pressure setpoints.

In a first aspect combinable with the general implementation, determining a local pressure setpoint comprises determining a local pressure setpoint for each of the plurality of fans that is sufficient to drive each of the fans at a substantially equal fan speed.

A second aspect combinable with any of the previous aspects includes comprising circulating air within the warm air plenum from a localized high airflow region of the warm air plenum at a first pressure to a localized low airflow region of the warm air plenum at a second pressure.

In a third aspect combinable with any of the previous aspects, determining a local pressure setpoint comprises identifying, from among the plurality of fans, a fan operating at a highest current fan speed; comparing a current fan speed for a particular fan of the plurality of fans to the highest current fan speed; and determining, based on the comparison, a local pressure setpoint sufficient to adjust the current fan speed of the particular fan so as to at least approach the highest current fan speed.

In a fourth aspect combinable with any of the previous aspects, determining a local pressure setpoint comprises determining an average current fan speed of the plurality of fans; comparing a current fan speed for a particular fan of the plurality of fans to the average current fan speed; and determining, based on the comparison, a local pressure setpoint sufficient to drive the current fan speed of the particular fan so as to at least approach the average current fan speed.

In a fifth aspect combinable with any of the previous aspects, modulating the fan speed comprises implementing a feedback control algorithm based on the localized pressure in the plenum proximate each of the cooling units and the local pressure setpoints.

In a sixth aspect combinable with any of the previous aspects, modulating the fan speed comprises adjusting a variable speed drive that is electrically-coupled to a motor associated with the fan.

A seventh aspect combinable with any of the previous aspects includes determining if a localized pressure in the warm air plenum proximate one of the fans has surpassed a predetermined threshold level; and determining the local pressure setpoints in response to determining that the threshold level has been surpassed.

An eighth aspect combinable with any of the previous aspects includes circulating a cooling fluid to each of the plurality of heat exchangers; circulating air drawn by the fans from the warm air plenum across through each of the heat exchangers; determining a temperature of air leaving each of the heat exchangers; determining a temperature of cooling fluid entering each of the heat exchangers; and individually modifying a flow rate of cooling fluid circulated to each of the heat exchangers to maintain a respective approach temperature setpoint for each of the heat exchangers, wherein the approach temperature is defined using a difference between the temperature of the air leaving a respective heat exchanger and the temperature of the cooling fluid circulated to the respective heat exchanger.

In another general implementation, a method for cooling a data center includes operating a plurality of fans that are associated with a plurality of cooling units to circulate warmed air from a warm air plenum through a plurality of cooling coils associated with the plurality of cooling units, each of the fans being associated with one or more cooling coils of the plurality of cooling coils; polling a pressure sensor positioned in or near the warm air plenum proximate each of the cooling units to determine a plurality of localized pressures; determining a plurality of pressure differentials, a particular pressure differential comprising a difference between a particular localized pressure and a pressure setpoint of the warm air plenum; and modulating a fan speed of each of the plurality of fans based on the plurality of pressure differentials.

A first aspect combinable with the general implementation includes identifying, from among the plurality of fans, a fan operating at a highest current fan speed; comparing a current fan speed of each of the plurality of fans to the highest current fan speed; and determining, based on the comparison, a pressure setpoint of the warm air plenum sufficient to drive the current fan speed of each of the fans towards the highest current fan speed.

A second aspect combinable with any of the previous aspects includes determining an average current fan speed of the plurality of fans; comparing a current fan speed of each of the plurality of fans to the average current fan speed; and determining, based on the comparison, a pressure setpoint of the warm air plenum sufficient to drive the current fan speed of each of the fans towards the average current fan speed.

Various implementations of systems and methods for providing cooling for areas containing electronic equipment may include one or more of the following advantages. For example, the maximum airflow capacity and/or the power consumption efficiency of the air circulation component in a data center cooling system can be increased by managing an incoming flow of heated air between modular cooling units. As another example, one or more implementations may provide for more homogeneous use of cooling units, e.g., fan coil units, in a data center by utilizing cooling units that are not arranged adjacent racks of electronic equipment, e.g., servers, to cool air circulated through racks that are adjacent to other cooling units.

These general and specific aspects may be implemented using a device, system or method, or any combinations of devices, systems, or methods. The details of one or more implementations are set forth in the accompanying drawings and the description below. Other features, objects, and advantages will be apparent from the description and drawings, and from the claims.

### DESCRIPTION OF DRAWINGS

FIGS. 1A and 1B illustrate a top and side view of an example implementation of a portion of a data center that includes a data center cooling unit;

FIG. 1C illustrates a side view of a portion of another example data center cooling unit;

FIG. 2A shows top of view of an example implementation of a portion of a data center that includes multiple modular cooling units;

FIG. 2B shows a diagram of the portion of the data center of FIG. 2A, which illustrates managing airflow between cooling units;

FIG. 3 illustrates an example multi-level control loop for controlling multiple in-row cooling units in a data center;

FIG. 4 shows a plan view of two rows in a computer data center with cooling units arranged between racks situated in the rows;

FIGS. 5A-5B show plan and sectional views, respectively, of a modular data center system; and

FIG. 6 illustrates an example method for managing airflow in a data center.

### DETAILED DESCRIPTION

This disclosure relates to systems and methods for providing cooling to areas that contain electronic equipment, such as computer server rooms and server racks in computer data centers. For example, in some implementations, a data center cooling system includes a number of cooling units that are positioned near a warm air plenum. The warm air plenum is open to, and shared by, a set of computing systems that generate heat. Each of the cooling units includes a working heat exchanger, which is operable to cool warmed air that is exhausted into the warm air plenum by the computing systems, and a motor-driven fan that draws the warmed air from the warm air plenum towards the heat exchanger. In some implementations, the cooling system also includes a control system in communication with the cooling units. The control system is configured to individually modulate the speed of each cooling unit fan so as to maintain a specified pressure gradient along the warm air plenum. In some cases, the pressure gradient can be leveraged to manage airflow between the cooling units, as discuss in detail herein.

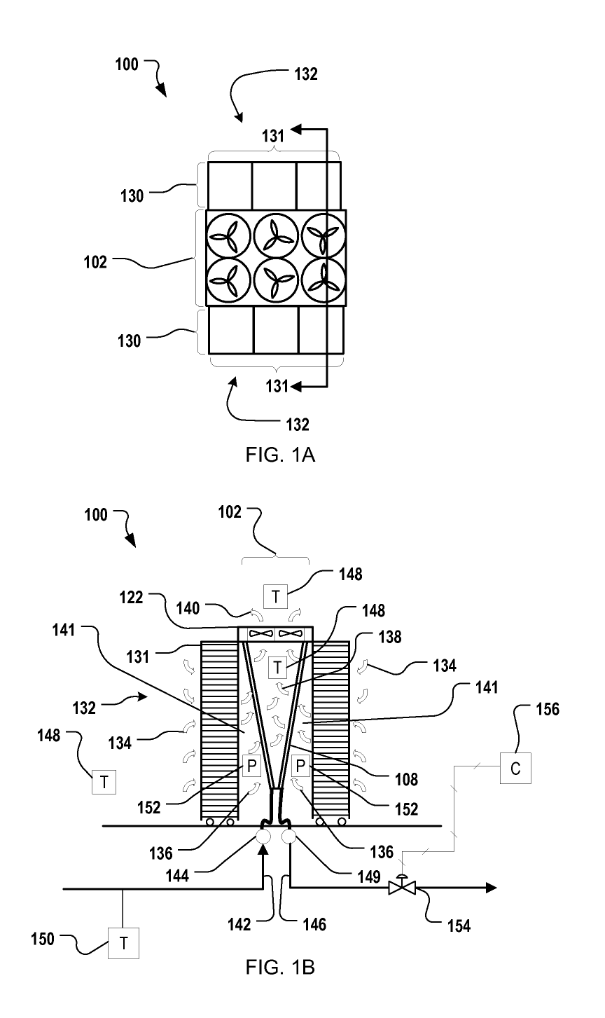

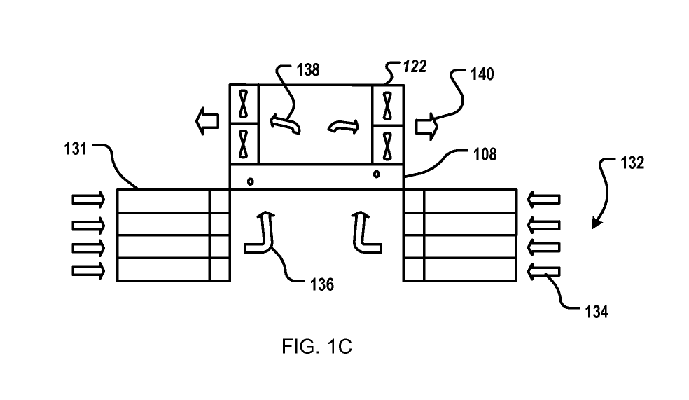

FIGS. 1A and 1B illustrate a top and cross-sectional side view of an example implementation of a portion of a data center 100 that includes a data center cooling unit 102. As illustrated, the data center 100 includes two rows 130 of racks 131 that support computers, e.g., servers, processors, motherboards, memory modules, trays, and otherwise. The rows 130 are arranged substantially parallel with each other, and are each adjacent to aisles in a human-occupiable workspace 132. The computers that are supported in the racks 131, in some implementations, may be open to the human-occupiable workspace 132 such that an airflow may be circulated from the workspace 132 through the racks 131 during normal operation of the system, and so that technicians may access particular devices without having to substantially interfere with airflow over the other devices, such as would happen if the rack were sealed and the technician had to open a door to access one of the devices.

Data center 100 also includes a cooling unit 102, which may also be referred to as a cooling unit or a cooling module, arranged between adjacent pairs of the rows 130 of racks 131. In some implementations, the cooling unit 102 may be positioned between computer racks in a data center to cool air that is warmed as it passes through the computer racks, and to circulate the cooled air back into a workspace, where it may be circulated through the computer racks again. To do so, the cooling unit 102 may be located in a long row, e.g., 20 feet or more, of similar cooling units that are positioned between rows of computer racks. The back faces of the racks, e.g., the faces opposite the workspace, may be adjacent to the cooling unit 102. Air may be drawn through front faces of the computer racks, e.g., the faces adjacent the workspace from which the racks are generally accessed, across various computing components such as processors and power supplies, and exhausted out the back of the racks to a warm air plenum 141 of the cooling unit 102. The cooling unit 102, or other cooling units in the row, may then cool the air and re-circulate it back into the workspace. In some implementations, airflow through the cooling units can be controlled or managed so that each of the cooling units is utilized efficiently. As described in detail below, this type of airflow management can be implemented by modulating one or more fans of each of the cooling units based on a setpoint of a warm air plenum pressure along the row of cooling units.

Each cooling unit 102 includes a number of fans 122, e.g., six as illustrated, that are arranged to circulate air from the workspace 132, through the racks 131 arranged in the rows 130. As illustrated, the ambient air 134 is circulated through the racks 131 and heated by heat generating electronic devices, e.g., servers, processors, uninterruptible power supplies, and other devices, into heated airflow 136. The heated airflow 136 is circulated through one or more cooling coils 108 of the cooling unit 102 to a cooling airflow 138. The cooling airflow 138 is circulated by the fans 122 to the workspace 132 as a leaving airflow 140 from the cooling units 102. The leaving airflow 140 is generally ducted, or otherwise directed, to an upper area of the data center 100 when the cooling unit 102 is installed, so that the fans 122 circulate air directly into the upper area. In other implementations, air may be routed into a raised floor, into a space between computer racks, into a ceiling space, or may be routed in other appropriate manners. In some implementations, a temperature of the cooling airflow 138 and the leaving airflow 140 may be substantially the same, e.g., where there is no electrical equipment or mixing with other air between the two. In some implementations, alternatively, the leaving airflow 140 may be slightly warmer than the cooling airflow 138 to account for, e.g., motor heat from fan motors (not shown) that drive the fans 122.

As illustrated, therefore, a volume defined between two substantially parallel rows 130 of racks 131 into which one or more cooling units 102 may be disposed may include one or more warm air plenums 141 and one or more cool air plenums. For example, the warm air plenums 141 may be defined by spaces into which the heated airflows 136 are circulated by the fans 122. In some implementations, the warm air plenums 141 may extend lengthwise beyond the rows 130 of racks 131. Alternatively, the warm air plenums 141 may be defined as substantially the same length as the rows 130 of racks 131. The cool air plenums may be defined by spaces into which the cooling airflow 138 is circulated. Thus the cooling coils 108 may thermally separate the warm air plenums 141 from the cool air plenums between the rows 130 of racks 131.

As illustrated, a cooling fluid supply 142, e.g., chilled water, chilled glycol, condenser water, and/or a mix of one of more fluid flows, is circulated, e.g., pumped, to the cooling coils 108 through a cooling fluid supply conduit 144. After circulating through the cooling coils 108 so that heat from the heated airflow 136 is transferred to the cooling fluid supply 142, cooling fluid return 146, e.g., the cooling fluid supply 142 leaving the cooling coils 108, is circulated from the cooling coils 108 and, for example, to a central cooling facility, via a cooling fluid return conduit 149. Although illustrated as arranged underneath a floor on which the rows 130 of racks 131 and the cooling units 102 are supported, the conduits 142 and/or 146 may be arranged in the workspace 132, above the cooling units 102, and/or in a separate overhead plenum.

The illustrated system also includes one or more temperature sensors 148, 150 and pressure sensors 152. For example, as illustrated, a temperature sensor 148 may be positioned in one or more locations to measure the temperature of the leaving airflow 140 from the cooling units 102. In some implementations, a temperature of the cooling airflow 138, the leaving airflow 140, and the ambient airflow 134 of the workspace 132 may be substantially similar and/or equal. Thus, measuring any one of the temperatures of these airflows may at least approximate a leaving air temperature of the cooling units 102. An additional temperature sensor 150 may be positioned to measure to measure a temperature of the cooling fluid supply 142. The pressure sensors 152 can be positioned at various points along the warm air plenums 141. For example, one or more pressure sensors 152 may be positioned at regular intervals along the warm air plenums 141 to measure the plenum pressure directly adjacent each of the cooling units 102.

In operation, the cooling units 102 may be controlled, e.g., with a control system, one or more individual controllers, and/or a main controller in the data center, to maintain a specified temperature. The temperature may be a single temperature, e.g., a temperature of an airflow exhausted from the fans, or, alternatively, an approach temperature. The approach temperature, in some implementations, may represent a difference between a temperature of an airflow leaving the cooling unit 102, e.g., the cooling airflow 138, the leaving airflow 140, the ambient airflow 134, and/or an average airflow temperature determined from one or more of these airflow temperatures, and a temperature of the cooling fluid supply 142. In some implementations, such a control, e.g., approach control, may provide for the adjustment of an amount, e.g., GPM, of cooling fluid supply 142 flowing through the cooling coils 108 to maintain a specific approach temperature. In some implementations, this approach control may include, for example, modulating, e.g., through servo control, a cooling fluid control valve 154, although the control valve 154 is illustrated as being incorporated into the fluid return piping, it may also be positioned in the fluid supply piping, or elsewhere in the system, with a controller 156, which may operate independently or according to commands from a main controller, to stabilize the approach temperature to a desired value. For example, since the amount of cooling fluid supply 142 required to remove a particular amount of heat, e.g., kW, generated by electronic devices in the racks 131 is inversely related to the approach temperature, varying the approach temperature may provide a “knob” to adjust the required GPM/kW to remove the generated heat by flowing the cooling fluid supply 142 through the cooling coils 108.

In some implementations, at any given snapshot in time, some racks 131 in the data center may be working harder, e.g., generating more kW, than other racks 131. So the required cooling power necessary at any particular location in the data center may vary over time. Approach control may, therefore, provide for the allocation of cooling fluid supply 142 automatically to “follow” the cooling load even though there may be no direct measurement of either power, e.g., kW, or flow rate, e.g., GPM, but rather, temperature measurements.

In some implementations, the approach control may be substantially static, e.g., approach temperature setpoint may not vary over time. For example, a static approach control may apply a single, fixed value for the approach temperature setpoint to all, or most, cooling units 102 in the data center. This may enable the allocation of cooling fluid, e.g., from a central plant or other cooling facility, to follow the cooling load based solely on information available locally at each cooling unit 102, e.g., leaving air temperature and entering cooling fluid temperature. This mode may allow the temperature on the data center floor to, for example, follow the seasons in accordance with weather impact on cooling plant capacity, e.g., by maximizing free cooling opportunities.

In some implementations, the approach control may be dynamic, e.g., approach temperature setpoint for one or more cooling units 102 may vary over time. For example, a dynamic approach control may allow for variance of a desired approach control setpoint spatially and temporally. The result may be that all, or most, of the available capacity of cooling fluid from a central cooling plant, e.g., a chiller plant, free cooling facility, and/or both, can be more optimally deployed. By dynamically varying the approach temperature setpoint in response to such factors as, for example, the types of electronic devices, e.g., servers, processors, memory components, etc., deployed at various locations on the data center floor; the types of services executed by such devices, e.g., web searching, electronic mail, and other web based services; an actual aggregate heat load on the data center floor; an actual cooling system capacity under current weather conditions, data center air temperatures, e.g., for airflows 134, 136, 138, and/or 140, can be moderated. Further, by dynamically varying the approach temperature, oversubscription, e.g., design of a cooling system with more cooling fluid available than used, of the cooling fluid supply 142 may be diminished.

In some implementations, implementation of a dynamic approach control scheme may utilize information that is not local to the particular cooling units 102. For example, in some implementations of dynamic approach control, information such as, for example, server deployments, aggregate server power draw, aggregate cooling plant capacities, weather values, and weather predictions in order to select and update an optimum approach setpoint for each individual cooling unit 102, a group of particular cooling units 102, and/or all of the cooling units 102. Further, while each cooling unit 102 can implement the static approach control locally, e.g., at the individual cooling unit 102, dynamic approach control may be implemented as a cloud based service.

As described above, fans 122 are arranged to circulate air through the cooling unit 102 so that the air may be cooled and be returned to the workspace 132. In the example shown, six fans in two rows of three are provided for the cooling unit 102. Each fan may be operated individually by a respective motor controller. The fan motor controllers can include variable speed drives, VSDs, for modulating the speed of the fans 122. In some implementations, the fans are operated to maintain a particular temperature, such as in the workspace 132, or in either of the cool and warm air plenums 141 of the cooling unit 102. Alternatively, the fans may be operated to maintain a particular pressure differential in the system. As one example, the fans may be operated to maintain a negligible pressure differential, e.g., a zero pressure differential, between a side of the cooling unit 102 where air is received from the computer racks, and the workspace 132. Where such a negligible pressure differential is maintained, any air-circulating equipment on the racks, such as fans associated with each tray in the racks, may operate as though it is working in an open room, because of the near-zero pressure difference. Such implementations may operate more efficiently than implementations in which circulating equipment must overcome a pressure differential. As another example, the fans may be operated to maintain a slightly negative pressure differential to avoid back-flow air circulation. In some examples, the pressure differential is maintained between about −0.03 and 0.03 inch of water.

The cooling units may also be controlled to maintain a specified pressure gradient, or pressure difference, between various locations along the warm air plenum. As discussed in further detail below, maintaining a pressure gradient can facilitate airflow management between multiple cooling units by driving air from a relatively high airflow region to a relatively low airflow region in the warm air plenum. This type of plenum pressure control scheme can be implemented in addition to, or in lieu of, the approach temperature control scheme described above. For example, a control system may be programmed to incorporate an approach temperature control loop into a more comprehensive control loop for airflow management between cooling units.

FIG. 1C illustrates a side view of a portion of another example data center cooling unit 102 situated between two rows of racks 131. In this example, a cooling coil 108 is positioned above the racks 131, so as to define a warm air plenum that is shared by the opposing rows or racks 131. The cooling coil 108 is oriented horizontally, with air flowing through it vertically. Two sets of fans 122 are positioned above the cooling coil 108 to circulate air from the workspace 132, through the racks 131. Similar to the previous example, the fans 122 can circulate the ambient air 134 in the workspace 132 through the racks 131, where the air is heated by heat generating electronic devices. The heated airflow 136 is exhausted into the shared warm air plenum between the racks 131 and circulated upward through the cooling coil 108. The cooling airflow 138 circulated back into the workspace 132 as a leaving airflow 140.

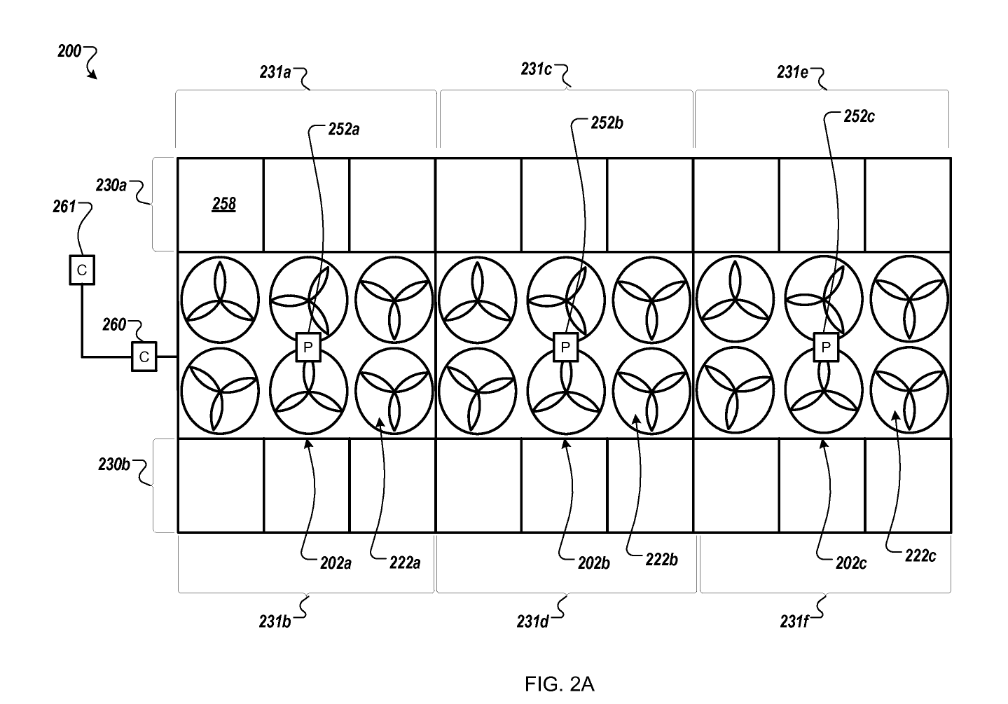

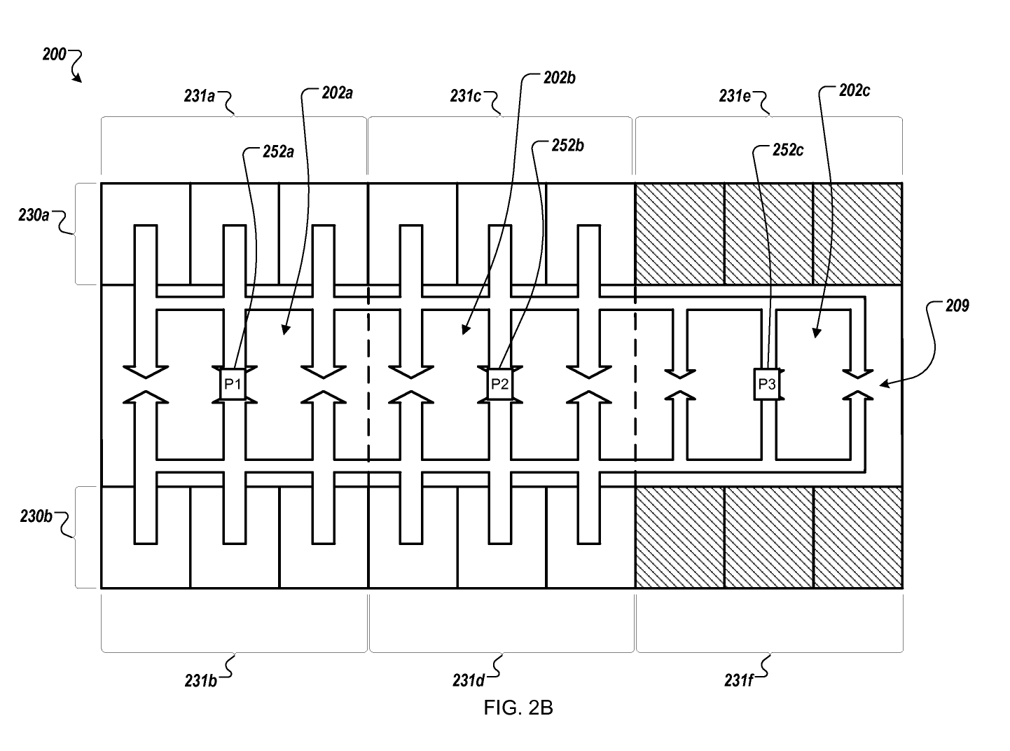

FIG. 2A shows top of view of another example implementation of a portion of a data center 200 that includes multiple modular cooling units 202a through 202c. Each of the cooling units 202a through 202c is similar to the cooling unit 102 shown in FIG. 1C. In this example, the cooling units 202a through 202c are shown in an end-to-end configuration. As noted below, however, modular type cooling units may also be spaced apart from one another according to a specified “pitch”. In some implementations, spreading the modular cooling units out over an area will provide a sufficient amount of cooling in a more cost efficient manner. In this case, the current illustration is provided merely for clarity and ease of discussion.

As shown, the three modular cooling units 202a through 202c are aligned with six computer racks 231a through 231f. The racks 231a through 231f are arranged into two parallel rows 230a and 230b on either side of the cooling units 202a through 202c. Specifically, cooling unit 202a is directly adjacent racks 231a and 231b; cooling unit 202b is directly adjacent racks 231c and 231d; and cooling unit 202c is directly adjacent racks 231e and 231f. Each of the racks 231a through 231f includes three vertical bays 258. The bays may each be connected so that the racks 231a through 231f are single units that move together, e.g., on wheels (not shown). Each bay may be approximately the width and depth of a computer motherboard, and may take a form much like that of a bakery or cafeteria rack, having supporting ledges on each side of a bay over which the motherboards may be slid and dropped into place like a tray in a bread rack. The racks 231a through 231f are backed up to the respective cooling units 202a through 202c. Accordingly, any computers supported in the racks 231a through 231f may exhaust warmed air directly into either of the warm air plenum 209, see FIG. 2B, below the horizontal cooling coils (not shown) of the cooling units 202a through 202c. The warm air plenum 209 is continuous along the rows 230a and 230b, and shared by the racks 231a through 231f, to allow air flow laterally across the cooling units, e.g., lengthwise along the rows 230a and 230b.

As shown, each of the cooling units 202a through 202c includes a set of fans 222a through 222c that operate to circulate air from the warm air plenum 209 to and through the respective cooling coils. In this example, each fan set 222a through 222c includes six fans. The fans can be controlled, e.g., individually or as a set, to drive the pressure at multiple locations or regions along the warm air plenum 209 towards a respective pressure setpoint. The location-specific pressures can be referred to as “local plenum pressures”, and the pressure set points can be referred to as “local pressure set points”. In some examples, the local pressure setpoints are near-zero and/or slightly below-zero to avoid imposing pressure demands on the fans associated with the trays in the racks, and to avoid back-flow air circulation.

The speed of the fans 222a through 222c can be modulated to drive a local plenum pressure towards a corresponding local pressure setpoint. For example, fans near a particular rack can be operated at an increased fan speed to drive a local plenum pressure towards a relatively lower local pressure setpoint, e.g., a pressure setpoint that is closer to zero or further below zero than the current local plenum pressure. Likewise, under the same conditions, the fans near the rack can be operated at a reduced fan speed to allow the local plenum pressure to approach a relatively higher local pressure setpoint. In some examples, the fan speed of a particular fan is directly modulated by an individual motor controller that includes a variable speed drive. Operating the fans at higher fan speeds comes at the price of higher power consumption. In some cases, power consumption varies cubically with fan speed, such that operating a fan at a maximum capacity, e.g., 100%, consumes about eight times as much power as operating the fan at about 50% capacity.

Collectively, a set of local plenum pressures in the warm air plenum 209 define a plenum pressure profile. In this example, a local plenum pressure is measured at three specified locations in the warm air plenum 209. The measurement locations of each set are separated from one another by a regular lengthwise distance interval along the warm air plenum 209. In this case, each of the pressure profile locations is in a region of the warm air plenum 209 between an opposing pair of racks 231a through 231f. Pressure sensors 252a through 252c are positioned to measure the local plenum pressures.

The motor controllers of the various fans may operate according to commands issued from a corresponding first level controller, e.g., first level controller 260 described below. The first level controller may operate each of the various fans individually, or in batch sets. There can be multiple first level controllers. In some implementations, there is a separate first level controller associated with each of the pressure sensors 252a through 252c. For instance, in this example, first level controller 260 is configured, e.g., appropriately programmed and electronically connected, to operate the set of fans 222a based on a local plenum pressure, measured by the pressure sensor 252a, and a corresponding local pressure setpoint. In some examples, these first level controllers are programmed to operate the motor controllers of the fans by implementing a control loop feedback routine, e.g., a proportional, proportional-derivative, proportional-intraoral, or proportional-integral-derivative control loop, to determine the appropriate fan speed(s), for achieving the local pressure setpoints. The local pressure setpoints are determined and issued as commands to the first level controller 260 by a second level controller 261.

The local pressure setpoints can be selected so as to induce a pressure gradient between the pressure profile locations of the warm air plenum 209. The pressure gradient may be sufficient, e.g., of appropriate magnitude and direction, to facilitate airflow management between the cooling units 202a and 202c by driving air from a relatively high airflow region of the warm air plenum 209 to a relatively low airflow region of the plenum. Airflow management refers to a control technique where a portion of the airflow entering the warm air plenum from one or more racks near a first cooling unit is purposefully driven to another location along the plenum to be handled by a second cooling unit. Airflow management can increase the power efficiency of a data center by reducing gross power consumption of the air circulation fans, e.g., fan sets 222a through 222c. For example, it is generally more efficient to drive multiple fans, or fan sets, at about 50% capacity than to drive a single fan, or fan set, at its maximum capacity. Airflow management can also increase the maximum airflow capacity provided by a given set of cooling units and their associated fans.

A region of the warm air plenum may experience relatively high airflow, as compared to the other regions of the plenum, when there are more computers supported in a particular rack than other racks on the row. For example, the amount of air exhausted into the warm air plenum may scale with the number of computers in the racks. A high airflow region can also form when the computers supported in a particular rack are working harder and generating more heat than the computers in other racks on the row. This may occur when the computers regulate their onboard fans to maintain a set temperature for the air exhausted into the warn air plenums. Regions of relatively low airflow may form under reverse conditions, e.g., low computer density in a rack or computer operated a low capacity.

FIG. 2B shows an example diagram of the portion of the data center 200 which illustrates airflow management between cooling units. In this example, there are no computers supported in racks 231e and 231f. As such, the region of the warm air plenum 209 that is adjacent racks 231e and 231f is a low air flow region compared to the regions of the plenum near the other racks 231a through 231d, which can be considered relatively high airflow regions. For example, variations of airflow may be caused by more “dense” machine usage, e.g., server usage, in one or more racks near particular regions of the plenum as compared to other regions of the plenum. For instance, in some racks, the servers may be operating at or near a maximum utilization and/or power draw as compared to servers in other racks, thereby requiring more airflow to cool the servers.

In some implementation, to facilitate airflow management, a pressure gradient is created within the warm air plenum 209 by controlling the fans 222a through 222c to meet a set of specified local pressure setpoints. For example, the local pressure setpoint for the region of the warm air plenum 209 between racks 231e and 231f may be lower than the local pressure setpoint in regions of the warm air plenum 209 between the other racks 231a through 231d. As shown, the resulting pressure gradient would drive airflow from the relatively high airflow regions between racks 231a through 231d towards the relatively low airflow region between racks 231e and 231f, as shown. Distribution of the plenum airflow in this manner allows the air circulation fans of the cooling units 202a through 202c to operate at a more energy efficient capacity, e.g., with all or most fans at the same or near the same fan speed.

As noted above, a second level controller, e.g., the second level controller 261, can operate one or more first level controllers. For example, the second level controller can be configured to determine appropriate local pressure setpoints for creating a pressure gradient along the warm air plenum that is sufficient to facilitate airflow management between cooling units, as described above. In some implementations, the second level controller is can monitor the local plenum pressures to determine if a region in the warm air plenum has surpassed a predetermined pressure threshold. Such a pressure increase may indicate that one or more of the fans is malfunctioning or currently operating at a maximum capacity that is insufficient to relieve the pressure of the exhausted airflow into the plenum. If the pressure threshold is surpassed, the second level controller can operate the first level controllers to facilitate airflow management between the cooling units to relieve the high pressure region.

In some cases, the second level controller is configured to implement a control loop feedback routine to determine the local pressure setpoints. As one example, the second level controller may determine the local pressure setpoints based on a highest current fan speed. In this case, the second level controller would determine, from among multiple fans operating to circulate air in a particular warm air plenum, e.g., all of the fans positioned along the plenum, or a subset of the fans along the plenum, a fan operating at a highest current fan speed. This determination can be made by directly comparing fan speeds or by comparing fan operating conditions that correspond with fan speed, e.g., duty cycle, power consumption rate, and input current. The highest current fan speed, or the corresponding operating condition, serves as a setpoint for the feedback control loop. That is, the second level control determines a local pressure setpoint that would drive the other fans towards the highest current fan speed. For example, the following example equation may be used to each feedback control cycle:

Pₛ=a*(FSₘₐₓ−FS_{L})+b

Pressure Setpoint=a×(Highest Current an Fan Speed−Local Current Fan Speed)+b (Eq. 1).

In this equation, Pₛ is the pressure setpoint, “a” is a tuning parameter that represents the pressure gradient slope which is less than zero to drive airflow from a high airflow region to a low airflow region, FSₘₐₓ is the highest current fan speed, FS_{L} is the local current fan speed, and “b” is an offset parameter that bounds the local pressure setpoint between a maximum and a minimum. The highest current fan speed may progressively decrease as the feedback control cycles are completed. After multiple cycles, all of the fans may be operating at an equal, or substantially equal, fan speed that is lower than the original highest current fan speed. As additional approach to determining the appropriate local pressure setpoints involves determining an average current fan speed for the multiple fans and using this value as a setpoint for the feedback control loop. In some implementations, Equation 1 may be expanded to a PI or PID controller, where the error may be determined according to the highest current fan speed in a particular group of modular cooling units and an average fan speed in the particular group of modular cooling units. For instance, the error may be calculated as:

FSₘₐₓ−FS_{L} (Eq. 2).

In an alternate implementation, a second level controller is configured to operate multiple first level controllers without using a feedback control scheme. For example, the second level controller may control the first level controllers based on a fan identified as operating at the highest current fan speed. In this case, the second level controller can issue commands to the first level controllers that cause all of the fans to operate at the same capacity as the identified fan.

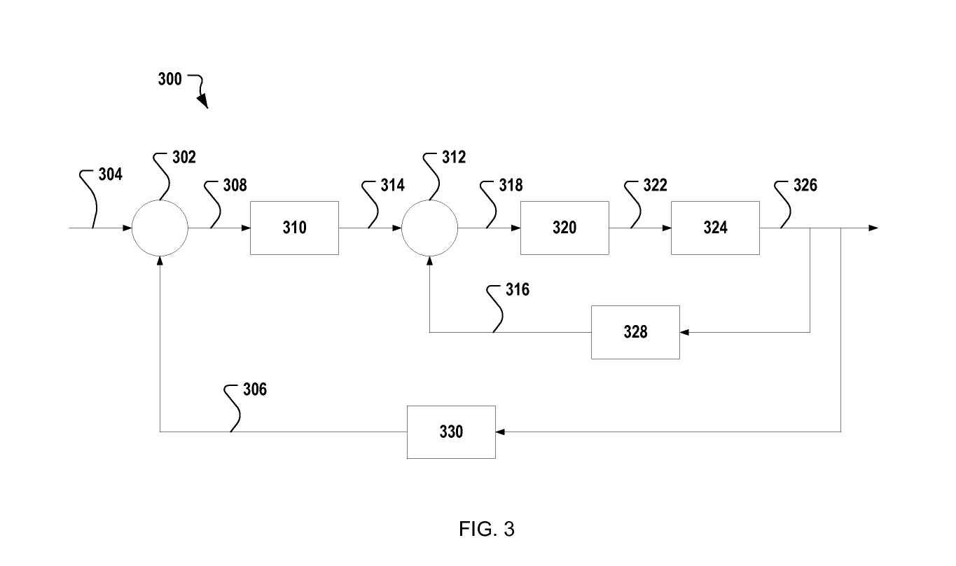

FIG. 3 illustrates an example multi-level control loop 300 for controlling multiple in-row cooling units 320 in a data center. In some implementations, the cooling units 320 are similar to, for example, the cooling unit 102 shown in FIGS. 1A, 1B and 1C, or other cooling apparatus described in the present disclosure. The control loop 300 may control the cooling units 320 to maintain a specified pressure gradient along a shared warm air plenum.

As illustrated, the control loop includes a second level input signal 304 and a second level feedback signal 306 that are provided to a second level summing function 302. In this example, the second level input signal 304 represents a desired fan speed, e.g., a highest current fan speed in the row, or an average fan speed, as described above. The second level feedback signal 306 represents the current fan speed of each fan in the row. The summing function 302 compares the second level input signal 304 to the second level feedback signal 306 and provides a second level error signal 308. The second level error signal represents the difference, or error, between the desired fan speed and each of the local fan speeds.

The second level error signal 308 is provided to a second level controller 310. In some implementations, the second level controller 310 may be a Proportional-Integral-Derivative, PID, controller. Alternatively, other control schemes, such as PI, PD, or otherwise, may be utilized. As another example, the control scheme may be implemented by a controller utilizing a state space scheme, e.g., a time-domain control scheme, representing a mathematical model of a physical system as a set of input, output and state variables related by first-order differential equations. The second level controller 310 receives the second level error signal 308 and generates a second level output signal 314 representing multiple local pressure setpoints. The local pressure setpoints may be designed to create a pressure gradient in the shared plenum to facilitate airflow management between the cooling units 320.

In this example, a first level control loop is embedded within the second level control loop. The first level control loop includes a first level summing function 312 that receives the second level output signal 314 and a first level feedback signal 316. The first level feedback signal 316 represents multiple measured local plenum pressures. The first level summing functions compares the second level output signal 314 to the first level feedback signal 316 and provides a first level error signal 318 to a first level controller 320. The first level controller receives the first level error signal 318 and generates a first level output signal 322, which includes a fan speed for each fan in the row. The fan speeds included in the first level output signal are designed to drive the local plenum pressures towards the local pressure setpoints. The first level output signal 322 is received by the cooling units 324 which modulate the respective fan speeds accordingly. Sensors 328 and 330 measure output 326 of the cooling units and generate the feedback signals 306 and 316. In some implementations.

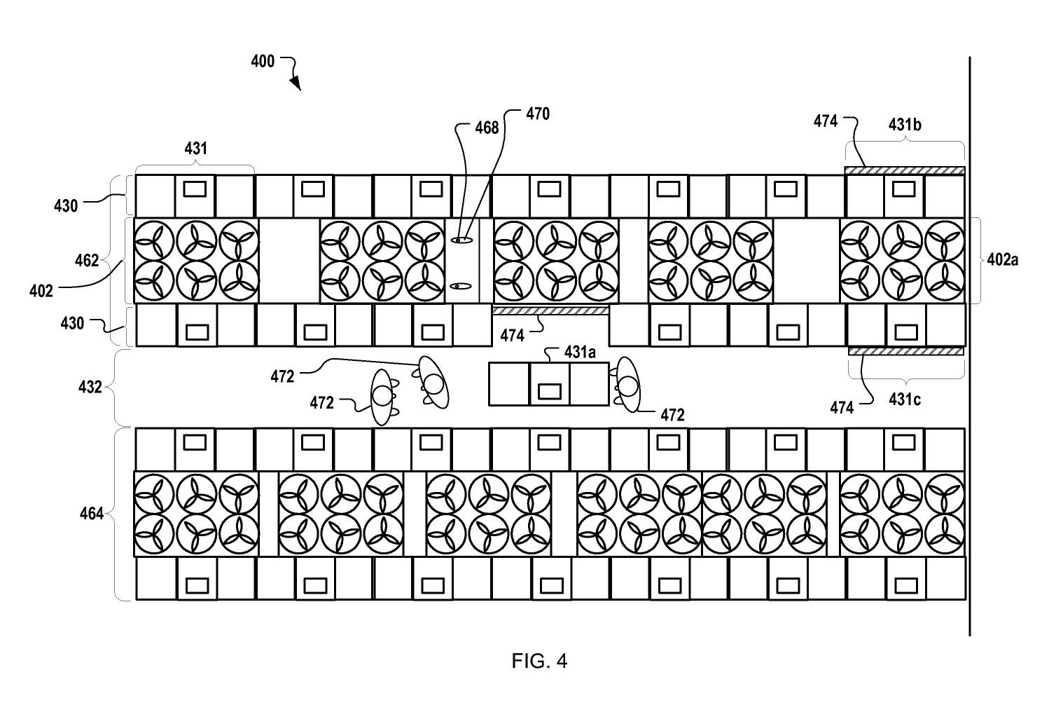

FIG. 4 shows a plan view of two rows 462 and 464, respectively, in a computer data center 402 with cooling units 400 arranged between racks situated in the rows. In some implementations, the data center 400 may implement one or more of the airflow management or approach temperature control schemes discussed above. In general, this figure illustrates certain levels of density and flexibility that may be achieved with structures like those discussed above. Each of the rows 462, 464 is made up of a row of cooling units 402 sandwiched by two rows 430 of computing racks 431. In some implementations, a row may also be provided with a single row of computer racks, such as by pushing the cooling units up against a wall of a data center, providing blanking panels all across one side of a cooling unit row, or by providing cooling units that only have openings on one side.

Each of the rows of computer racks and rows of cooling units in each of rows 462, 464 may have a certain cooling unit density. In particular, a certain number of such computing or cooling units may repeat over a certain length of a row such as over 100 feet. Or, expressed in another way, each of the cooling units may repeat once every X feet in a row.

In this example, each of the rows is approximately 40 feet long. Each of the three-bay racks is approximately six feet long. And each of the cooling units is slightly longer than each of the racks. Thus, for example, if each rack were exactly six feet long and all of the racks were adjoining, the rack cooling units would repeat every six feet. As a result, the racks could be said to have a six-foot “pitch.”

As can be seen, the pitch for the cooling unit rows is different in row 462 than in row 464. Row 462 contains five cooling units 402, while row 464 contains six cooling units 402. Thus, if one assumes that the total length of each row is 42 feet, then the pitch of cooling units in row 464 would be 7 feet, 42/6, and the pitch of cooling units in row 462 would be 8.4 feet, 42/5.

The pitch of the cooling units and of the computer racks may differ, and the respective lengths of the two kinds of apparatuses may differ, because warm air is able to flow up and down the rows 430. Thus, for example, a bay or rack may exhaust warm air in an area in which there is no cooling unit to receive it. But that warm air may be drawn laterally down the row and into an adjacent module, where it is cooled and circulated back into the work space, such as aisle 432.

Row 462 may receive less cooling air than would row 464. However, it is possible that row 462 needs less cooling, so that the particular number of cooling units in each row has been calculated to match the expected cooling requirements. For example, row 462 may be outfitted with trays holding new, low-power microprocessors; row 462 may contain more storage trays, which are generally lower power than processor trays, and fewer processor trays; or row 462 may generally be assigned less computationally intensive work than is row 464.

In addition, the two rows 462 and 464 may both have had an equal number of cooling units at one time, but then an operator of the data center may have determined that row 462 did not need as many modules to operate effectively. As a result, the operator may have removed one of the modules so that it could be used elsewhere.

The particular density of cooling units that is required may be computed by first computing the heat output of computer racks on both sides of an entire row. The amount of cooling provided by one cooling unit may be known, and may be divided into the total computed heat load and rounded up to get the number of required cooling units. Those cooling units may then be spaced along a row so as to be as equally spaced as practical, or to match the location of the heat load as closely as practical, such as where certain computer racks in the row generate more heat than do others. Also, as explained in more detail below, the row of cooling units may be aligned with rows of support columns in a facility, and the cooling units may be spaced along the row so as to avoid hitting any columns.

Where there is space between cooling units, a blanking panel 468 may be used to block the space so that air from the warm air capture plenum does not escape upward into the work space. The panel 468 may simply take the form of a paired set of sheet metal sheets that slide relative to each other along slots 470 in one of the sheets, and can be fixed in location by tightening a connector onto the slots.

FIG. 4 also shows a rack 431a being removed for maintenance or replacement. The rack 431a may be mounted on caster wheels so that one of technicians 472 could pull it forward into aisle 432 and then roll it away. In the figure, a blanking panel 474 has been placed over an opening left by the removal of rack 431a to prevent air from the work space from being pulled into the warm air capture plenum, or to prevent warm air from the plenum from mixing into the work space. The blanking panel 474 may be a solid panel, a flexible sheet, or may take any other appropriate form.

In one implementation, a space may be laid out with cooling units mounted side-to-side for maximum density, but half of the cooling units may be omitted upon installation, e.g., so that there is 50% coverage. Such an arrangement may adequately match the cooling unit capacity, e.g., about four racks per cooling unit, where the racks are approximately the same length as the cooling units and mounted back-to-back on the cooling units, to the heat load of the racks. Where higher powered racks are used, the cooling units may be moved closer to each other to adapt for the higher heat load, e.g., if rack spacing is limited by maximum cable lengths, or the racks may be spaced from each other sufficiently so that the cooling units do not need to be moved. In this way, flexibility may be achieved by altering the rack pitch or by altering the cooling unit pitch.

In this example, racks 431b and 431c are empty, e.g., having no computers supported therein, and are therefore blocked off with a set of blanking panels 474 to prevent airflow through the racks. This arrangement forms a relatively low airflow region in the shared warm air plenum near the racks 431b and 431c. To make use of the adjacent cooling unit 402a, an appropriate airflow management technique can be used drive air from relatively high airflow regions in the plenum, e.g., regions in the plenum near active computer racks, to be drawn towards the low airflow region adjacent the racks 431b and 431c. As noted above, distribution of the airflow in this manner allows the cooling units to operate at a more energy efficient capacity.

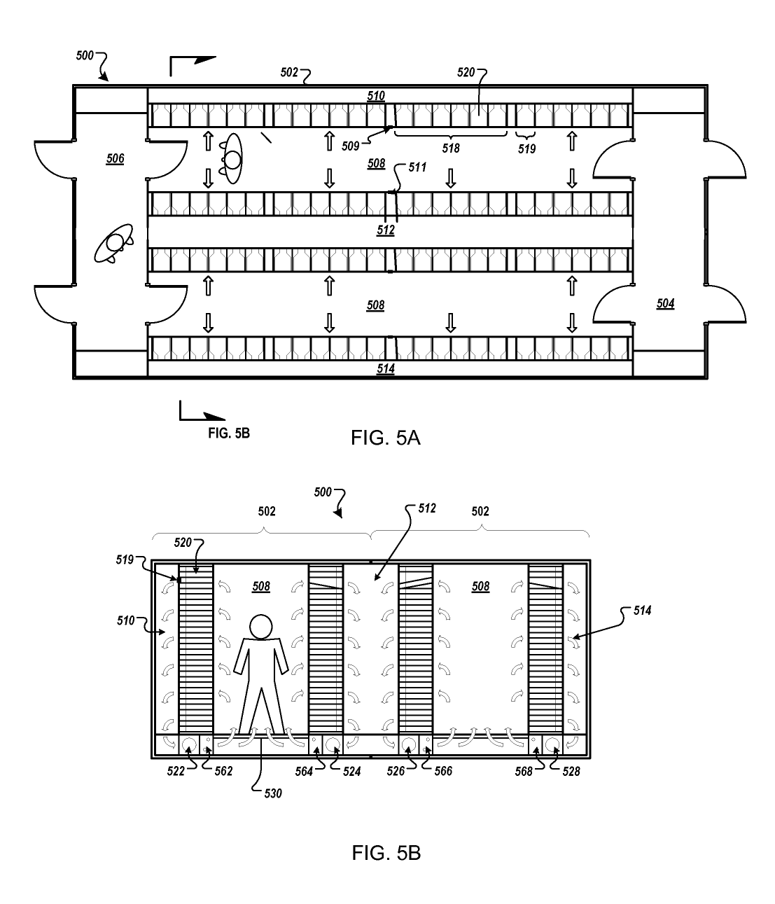

FIGS. 5A-5B show plan and sectional views, respectively, of a modular data center system. In some implementations, one of more data processing centers 500 may implement one or more of the airflow management or approach temperature control schemes discussed above. The system may include one of more data processing centers 500 in shipping containers 502. Although not shown to scale in the figure, each shipping container 502 may be approximately 40 feet along, 8 feet wide, and 9.5 feet tall, e.g., a 1AAA shipping container. In other implementations, the shipping container can have different dimensions, e.g., the shipping container can be a 1CC shipping container. Such containers may be employed as part of a rapid deployment data center.

Each container 502 includes side panels that are designed to be removed. Each container 502 also includes equipment designed to enable the container to be fully connected with an adjacent container. Such connections enable common access to the equipment in multiple attached containers, a common environment, and an enclosed environmental space.

Each container 502 may include vestibules 504 and 506 at each end of the relevant container 502. When multiple containers are connected to each other, these vestibules provide access across the containers. One or more patch panels or other networking components to permit for the operation of data processing center 500 may also be located in vestibules 504 and 506. In addition, vestibules 504 and 506 may contain connections and controls for the shipping container. For example, cooling pipes, e.g., from heat exchangers that provide cooling water that has been cooled by water supplied from a source of cooling such as a cooling tower, may pass through the end walls of a container, and may be provided with shut-off valves in the vestibules 504 and 506 to permit for simplified connection of the data center to, for example, cooling water piping. Also, switching equipment may be located in the vestibules 504 and 506 to control equipment in the container 502. The vestibules 504 and 506 may also include connections and controls for attaching multiple containers 502 together. As one example, the connections may enable a single external cooling water connection, while the internal cooling lines are attached together via connections accessible in vestibules 504 and 506. Other utilities may be linkable in the same manner.

Central workspaces 508 may be defined down the middle of shipping containers 502 as aisles in which engineers, technicians, and other workers may move when maintaining and monitoring the data processing center 500. For example, workspaces 508 may provide room in which workers may remove trays from racks and replace them with new trays. In general, each workspace 508 is sized to permit for free movement by workers and to permit manipulation of the various components in data processing center 500, including providing space to slide trays out of their racks comfortably. When multiple containers 502 are joined, the workspaces 508 may generally be accessed from vestibules 504 and 506.

A number of racks such as rack 519 may be arrayed on each side of a workspace 508. Each rack may hold several dozen trays, like tray 520, on which are mounted various computer components. The trays may simply be held into position on ledges in each rack, and may be stacked one over the other. Individual trays may be removed from a rack, or an entire rack may be moved into a workspace 508.

The racks may be arranged into a number of bays such as bay 518. In the figure, each bay includes six racks and may be approximately 8 feet wide. The container 502 includes four bays on each side of each workspace 508. Space may be provided between adjacent bays to provide access between the bays, and to provide space for mounting controls or other components associated with each bay. Various other arrangements for racks and bays may also be employed as appropriate.

Warm air plenums 510 and 514 are located behind the racks and along the exterior walls of the shipping container 502. A larger joint warm air plenum 512 is formed where the two shipping containers are connected. The warm air plenums receive air that has been pulled over trays, such as tray 520, from workspace 508. The air movement may be created by fans located on the racks, in the floor, or in other locations. For example, if fans are located on the trays and each of the fans on the associated trays is controlled to exhaust air at one temperature, such as 40° C., 42.5° C., 45° C., 47.5° C., 50° C., 52.5° C., 55° C., or 57.5° C., the air in plenums 510, 512, and 514 will generally be a single temperature or almost a single temperature. As a result, there may be little need for blending or mixing of air in warm air plenums 510, 512, and 514. Alternatively, if fans in the floor are used, there will be a greater degree temperature variation from air flowing over the racks, and greater degree of mingling of air in the plenums 510, 512, and 514 to help maintain a consistent temperature profile.

FIG. 5B shows a sectional view of the data center from FIG. 5A. This figure more clearly shows the relationship and airflow between workspaces 508 and warm air plenums 510, 512, and 514. In particular, air is drawn across trays, such as tray 520, by fans at the back of the trays 519. Although individual fans associated with single trays or a small number of trays, other arrangements of fans may also be provided. For example, larger fans or blowers, may be provided to serve more than one tray, to serve a rack or group or racks, or may be installed in the floor, in the plenum space, or other location.

Air may be drawn out of warm air plenums 510, 512, and 514 by fans 522, 524, 526, and 528. Fans 522, 524, 526, and 528 may take various forms. In one exemplary implementation, the may be in the form of a number of squirrel cage fans. The fans may be located along the length of container 502, and below the racks, as shown in FIG. 5B. A number of fans may be associated with each fan motor, so that groups of fans may be swapped out if there is a failure of a motor or fan.

An elevated floor 530 may be provided at or near the bottom of the racks, on which workers in workspaces 508 may stand. The elevated floor 530 may be formed of a perforated material, of a grating, or of mesh material that permits air from fans 522 and 524 to flow into workspaces 508. Various forms of industrial flooring and platform materials may be used to produce a suitable floor that has low pressure losses.

Fans 522, 524, 526, and 528 may blow heated air from warm air plenums 510, 512, and 514 through cooling coils 562, 564, 566, and 568. The cooling coils may be sized using well known techniques, and may be standard coils in the form of air-to-water heat exchangers providing a low air pressure drop, such as a 0.5 inch pressure drop. Cooling water may be provided to the cooling coils at a temperature, for example, of 10, 15, or 20 degrees Celsius, and may be returned from cooling coils at a temperature of 20, 25, 30, 35, or 40 degrees Celsius. In other implementations, cooling water may be supplied at 15, 10, or 20 degrees Celsius, and may be returned at temperatures of about 25 degrees Celsius, 30 degrees Celsius, 35 degrees Celsius, 45 degrees Celsius, 50 degrees Celsius, or higher temperatures. The position of the fans 522, 524, 526, and 528 and the coils 562, 564, 566, and 568 may also be reversed, so as to give easier access to the fans for maintenance and replacement. In such an arrangement, the fans will draw air through the cooling coils.

The particular supply and return temperatures may be selected as a parameter or boundary condition for the system, or may be a variable that depends on other parameters of the system. Likewise, the supply or return temperature may be monitored and used as a control input for the system, or may be left to range freely as a dependent variable of other parameters in the system. For example, the temperature in workspaces 508 may be set, as may the temperature of air entering plenums 510, 512, and 514. The flow rate of cooling water and/or the temperature of the cooling water may then vary based on the amount of cooling needed to maintain those set temperatures.

The particular positioning of components in shipping container 502 may be altered to meet particular needs. For example, the location of fans and cooling coils may be changed to provide for fewer changes in the direction of airflow or to grant easier access for maintenance, such as to clean or replace coils or fan motors. Appropriate techniques may also be used to lessen the noise created in workspace 508 by fans. For example, placing coils in front of the fans may help to deaden noise created by the fans. Also, selection of materials and the layout of components may be made to lessen pressure drop so as to permit for quieter operation of fans, including by permitting lower rotational speeds of the fans. The equipment may also be positioned to enable easy access to connect one container to another, and also to disconnect them later. Utilities and other services may also be positioned to enable easy access and connections between containers 502.

Airflow in warm air plenums 510, 512, and 514 may be controlled via pressure sensors. For example, the fans may be controlled so that the pressure in warm air plenums is roughly equal to the pressure in workspaces 508. Taps for the pressure sensors may be placed in any appropriate location for approximating a pressure differential across the trays 520. For example, one tap may be placed in a central portion of plenum 512, while another may be placed on the workspace 508 side of a wall separating plenum 512 from workspace 508. For example the sensors may be operated in a conventional manner with a control system to control the operation of fans 522, 524, 526, and 528. One sensor may be provided in each plenum, and the fans for a plenum or a portion of a plenum may be ganged on a single control point.

For operations, the system may better isolate problems in one area from other components. For instance, if a particular rack has trays that are outputting very warm air, such action will not affect a pressure sensor in the plenum, even if the fans on the rack are running at high speed, because pressure differences quickly dissipate, and the air will be drawn out of the plenum with other cooler air. The air of varying temperature will ultimately be mixed adequately in the plenum, in a workspace, or in an area between the plenum and the workspace.

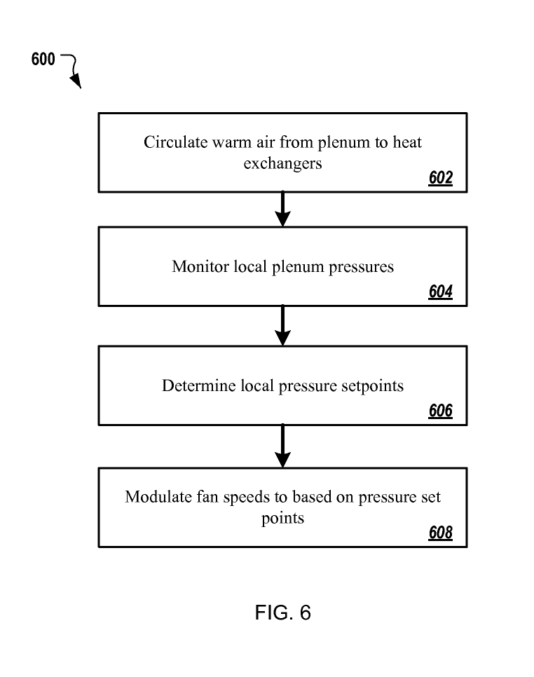

FIG. 6 illustrates an examples method 600 for cooling a data center based on plenum pressure to facilitate airflow management. Method 600 may be implemented, for example, by or with any appropriate cooling system for a data center, such as, the cooling systems, modules, and apparatus described herein.

Method 600 may begin at step 602, when air exhausted into a warm air plenum is circulated to multiple heat exchangers. In some examples, the warm air plenum is shared by multiple in-row cooling units in a data center. The heat exchangers are incorporated into the cooling units. The cooling units also include one or more fans that circulate the warmed air to the heat exchangers. The fans may be controlled to maintain a specified pressure in the plenum. In some examples, the cooling units are positioned between racks that support electronic equipment, e.g., computers. During operation, the electronic equipment generates heat that is dissipated by flowing cool air across the racks. The warmed air is exhausted from the racks into the shared warm air plenum. The racks may be in the form of open bays, e.g., open at front and back sides to an ambient workspace and warm air plenum, respectively. The racks may therefore be serviceable from one or both of the front or back sides during operation, e.g., while cooling airflow is circulated through the racks, of the racks and cooling system.

At step 604, multiple local plenum pressures are determined. The local plenum pressures are measured, e.g., by a static pressure sensor, at various points lengthwise, along the shared warm air plenum. For example, a respective local plenum pressure can be measured at a point adjacent each of the racks. Accordingly, determining multiple local plenum pressures can be accomplished by polling the appropriate pressure sensors. Of course, more or fewer local plenum pressures can be determined in various implementations.

At step 606, multiple local pressure setpoints are determined. The local pressure setpoints correspond to the measured local plenum pressures. In some examples, the local pressure setpoints are generated so as to create a pressure gradient along the warm air plenum. The pressure gradient may be sufficient to facilitate airflow management across the cooling units, driving air from a localized high airflow region of the warm air plenum towards a localized low airflow region of the plenum. In some examples, the local pressure setpoints are designed to drive the fans of the cooling units at a substantially equal fan speed. For instance, the local pressure setpoints can be determined by identifying a cooling unit fan that is operating at a highest current fan speed, and determining, based on a comparison of the highest current fan speed with fan speeds of the other cooling unit fans, local pressure setpoints that are sufficient to adjust the fans speeds of the other cooling unit fans so as to at least approach the highest current fan speed. Alternatively, the local pressure setpoints can also be determined by finding an average fan speed of the cooling unit fans, and determining, based on a comparison of the average fan speed with the actual fan speeds of the cooling unit fans, local pressure setpoints that are sufficient adjust the fans speeds of the other cooling unit fans so as to at least approach the average fan speed.

At step 608, the speeds of the fans in the cooling units are modulated, e.g., using a variable speed drive, based on the pressure setpoints. For example, the fan speeds can be increased to achieve a lower local plenum pressure, or reduced to achieve a higher local plenum pressure. In some examples, the fan speeds are modulated by implementing a feedback control algorithm based on the corresponding local plenum pressure and the local pressure setpoint.

A control system can be provided to operate the cooling units. For example, the control system may include one or more first and second level controllers to implement the method 600. The second level controllers can be configured to determine the appropriate local plenum pressures, while the first level controllers are configured to modulate the fan speeds based on the local plenum pressures. Accordingly, the control system may be operable to implement a multi-level feedback servo control loop where second level controllers operate on an outer control loop that incorporates the inner control loop of the first level controllers. Further, in some examples, the airflow management control method 600 can be combined with other appropriate control schemes, e.g., an approach temperature control scheme, to cool a data center more efficiently.

A number of implementations have been described. Nevertheless, it will be understood that various modifications may be made. For example, other methods described herein besides those, or in addition to those, illustrated in FIG. 6 can be performed. Further, the illustrated steps of method 600 can be performed in different orders, either concurrently or serially. Further, steps can be performed in addition to those illustrated in method 600, and some steps illustrated in method 600 can be omitted without deviating from the present disclosure. Further, various combinations of the components described herein may be provided for implementations of similar apparatuses. Further, in some example implementations of the cooling apparatus described herein, a liquid-to-liquid heat exchanger may be included in addition to or in place of a fan and liquid-to-air heat exchanger in order to cool electronic equipment supported in one or more racks. For instance, the liquid-to-liquid heat exchanger may receive heat from the electronic equipment into a working liquid and transfer the heat to a cooling fluid. Accordingly, other implementations are within the scope of the present disclosure.

What is claimed is:

1. A data center cooling system comprising:
a plurality of cooling units positioned adjacent a warm air plenum that is in airflow communication with a plurality of electronic devices supported in a plurality of racks, each of the cooling units comprising:
a heat exchanger arranged to cool warmed air circulated into the warm air plenum from a human-occupiable workspace adjacent the plurality of racks opposite the plurality of cooling units; and
a fan arranged to circulate the warmed air from the warm air plenum through the heat exchanger and to the human-occupiable workspace; and
a control system electrically coupled to the fan and configured to modulate a fan speed of the fan of each cooling unit to induce a pressure gradient in the warm air plenum.

2. The data center cooling system of claim 1, wherein the control system comprises:
a plurality of first level controllers, each of the first level controllers associated with a respective cooling unit and configured to control the fan speed of the fan of the respective cooling unit based on a received local pressure setpoint, wherein the local pressure setpoint comprises a pressure setpoint for a location in the warm air plenum directly adjacent the respective cooling unit; and
a second level controller in communication with each of the first level controllers, the second level controller being configured to determine the local pressure setpoint for each of the first level controllers based on a current fan speed of the fan of each cooling unit.

3. The data center cooling system of claim 2, wherein the second level controller is configured to determine if a pressure in a region of the warm air plenum has surpassed a predetermined threshold level.

4. The data center cooling system of claim 2, wherein the second level controller is configured to modulate the fan speed of the fan of each cooling unit in response to determining that a pressure in a region of the warm air plenum has surpassed the threshold level.

5. The data center cooling system of claim 2, wherein the second level controller is configured to determine, from among the fans of the plurality of cooling units, a fan operating at a highest current fan speed.

6. The data center cooling system of claim 5, wherein the local pressure setpoint for each of the first level controllers is sufficient to cause the plurality of first level controllers to drive the fan of each cooling unit at a speed substantially equal to the highest current fan speed.

7. The data center cooling system of claim 5, wherein the local pressure setpoint for each of the first level controllers is sufficient to cause the plurality of first level controllers to drive the fan of each cooling unit at a substantially equal fan speed, which is lower than the highest current fan speed.

8. The data center cooling system of claim 2, wherein the second level controller is configured to determine an average current fan speed of the fans of the plurality of cooling units.

9. The data center cooling system of claim 8, wherein the local pressure setpoint for each of the first level controllers is sufficient to cause the plurality of first level controllers to drive the fan of each cooling unit at a speed substantially equal to the average current fan speed.

10. The data center cooling system of claim 2, wherein the second level controller is configured to determine the local pressure setpoint for each of the first level controllers dynamically, at predetermined time intervals.

11. The data center cooling system of claim 1, wherein the warm air plenum extends continuously lengthwise along a row of racks, and is defined between one side of the heat exchangers and the racks.

12. The data center cooling system of claim 11, wherein the pressure gradient extends between two locations in the warm air plenum separated lengthwise along the row of racks.

13. The data center cooling system of claim 12, wherein one of the two locations is directly adjacent a first of the cooling units and the other of the two locations is directly adjacent a second of the cooling units.

14. The data center cooling system of claim 1, wherein each of the cooling units further comprises a pressure sensor arranged to measure a local plenum pressure proximate the fan, the pressure sensor in communication with the control system.

15. The data center cooling system of claim 1, wherein the pressure gradient is sufficient to cause air in the warm air plenum to flow from a localized high airflow region of the warm air plenum to a localized low airflow region of the warm air plenum.

16. The data center cooling system of claim 1, wherein control system is configured to control the fan of a first cooling unit to circulate air from a localized high airflow region adjacent the first cooling unit, along the warm air plenum, towards a localized low airflow region adjacent a second cooling unit that is spaced apart from the first cooling unit.

17. The data center cooling system of claim 1, wherein each of the cooling units further comprises a control valve coupled to the heat exchanger, the control valve being in communication with the control system, and
wherein the control system is further configured to individually modulate the control valve of each cooling unit, to open or close the control valve to substantially maintain an approach temperature setpoint associated with the cooling unit, wherein the approach temperature is defined by a difference between a temperature of an airflow circulated from the cooling unit and a temperature of a cooling fluid circulated to the cooling unit.

18. The data center cooling system of claim 1, wherein the control system is configured to:
determine, from among the fans of the plurality of cooling units, a fan operating at a highest current fan speed; and
drive the fan of each cooling unit at a speed substantially equal to the highest current fan speed.

19. A method for cooling a data center, the method comprising:
operating a plurality of fans to circulate air from a human-occupiable workspace, through one or more computer racks into a warm air plenum a warm air plenum, and through a plurality of heat exchangers, each of the fans being associated with one or more particular heat exchangers of the plurality of heat exchangers;
monitoring a localized pressure in the warm air plenum proximate each of the fans;
determining a local pressure setpoint for each of the plurality of fans to induce a pressure gradient in the warm air plenum; and
modulating a fan speed of each of the plurality of fans to satisfy the local pressure setpoints.

20. The method of claim 19, wherein determining a local pressure setpoint comprises determining a local pressure setpoint for each of the plurality of fans that is sufficient to drive each of the fans at a substantially equal fan speed.

21. The method of claim 19, further comprising circulating air within the warm air plenum from a localized high airflow region of the warm air plenum at a first pressure to a localized low airflow region of the warm air plenum at a second pressure.

22. The method of claim 19, wherein determining a local pressure setpoint comprises:
identifying, from among the plurality of fans, a fan operating at a highest current fan speed;
comparing a current fan speed for a particular fan of the plurality of fans to the highest current fan speed; and
determining, based on the comparison, a local pressure setpoint sufficient to adjust the current fan speed of the particular fan so as to at least approach the highest current fan speed.

23. The method of claim 19, wherein determining a local pressure setpoint comprises:
determining an average current fan speed of the plurality of fans;
comparing a current fan speed for a particular fan of the plurality of fans to the average current fan speed; and
determining, based on the comparison, a local pressure setpoint sufficient to drive the current fan speed of the particular fan so as to at least approach the average current fan speed.

24. The method of claim 19, wherein modulating the fan speed comprises implementing a feedback control algorithm based on the localized pressure in the plenum proximate each of the cooling units and the local pressure setpoints.

25. The method of claim 19, wherein modulating the fan speed comprises adjusting a variable speed drive that is electrically-coupled to a motor associated with the fan.

26. The method of claim 19, further comprising:
determining if a localized pressure in the warm air plenum proximate one of the fans has surpassed a predetermined threshold level; and
determining the local pressure setpoints in response to determining that the threshold level has been surpassed.

27. The method of claim 19, further comprising:
circulating a cooling fluid to each of the plurality of heat exchangers;
circulating air drawn by the fans from the warm air plenum across through each of the heat exchangers;
determining a temperature of air leaving each of the heat exchangers;
determining a temperature of cooling fluid entering each of the heat exchangers; and
individually modifying a flow rate of cooling fluid circulated to each of the heat exchangers to maintain a respective approach temperature setpoint for each of the heat exchangers, wherein the approach temperature is defined using a difference between the temperature of the air leaving a respective heat exchanger and the temperature of the cooling fluid circulated to the respective heat exchanger.

28. A method for cooling a data center, the method comprising:
operating a plurality of fans that are associated with a plurality of cooling units to circulate warmed air from a warm air plenum through a plurality of cooling coils associated with the plurality of cooling units, each of the fans being associated with one or more cooling coils of the plurality of cooling coils;
polling a pressure sensor positioned in or near the warm air plenum proximate each of the cooling units to determine a plurality of localized pressures;
determining a plurality of pressure differentials, a particular pressure differential comprising a difference between a particular localized pressure and a pressure setpoint of the warm air plenum; and
modulating a fan speed of each of the plurality of fans based on the plurality of pressure differentials.

29. The method of claim 28, further comprising:
identifying, from among the plurality of fans, a fan operating at a highest current fan speed;
comparing a current fan speed of each of the plurality of fans to the highest current fan speed; and
determining, based on the comparison, a pressure setpoint of the warm air plenum sufficient to drive the current fan speed of each of the fans towards the highest current fan speed.

30. The method of claim 28, further comprising:
determining an average current fan speed of the plurality of fans;
comparing a current fan speed of each of the plurality of fans to the average current fan speed; and
determining, based on the comparison, a pressure setpoint of the warm air plenum sufficient to drive the current fan speed of each of the fans towards the average current fan speed.
